(19) United States
(12) Patent Application Publication
(10) Pub. No.: US 2011/0019640 A1
(43) Pub. Date: Jan. 27, 2011

(54) MOBILE NODE, TAKE-OVER POINT OF ATTACHMENT AND HANDOVER METHOD THEREOF FOR USE IN A HETEROGENEOUS WIRELESS NETWORK SYSTEM

(75) Inventors: Chia-Hsiang CHANG, Taipei City (TW); Chih-Peng HSU, Danshui Township (TW); Chih-Hsiang HO, Taipei City (TW); Heng-lang HSU, Taipei City (TW); I-Hung LIN, Taipei City (TW)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: Institute for Information Industry, Taipei (TW)

(21) Appl. No.: 12/560,126

(22) Filed: Sep. 15, 2009

(30) Foreign Application Priority Data
Jul. 22, 2009 (TW) 098124703

(51) Int. Cl. H04W 36/00

(52) U.S. Cl. 370/331

(57) ABSTRACT

A mobile node (MN), a take-over point of attachment (PoA) and handover methods thereof for use in a heterogeneous wireless network system are provided. The heterogeneous wireless network system comprises a gateway, a first wireless network and a second wireless network which is heterogeneous to the first wireless network. The first wireless network and the second wireless network comprise the take-over PoA and an original PoA respectively. The take-over PoA and the original PoA have an overlapping service area. The MN receives a network service from the gateway via the original PoA so far. As soon as the MN enters the overlap service area, the MN builds a link with the take-over PoA in the data-link layer immediately so that the original PoA may handover to the take-over PoA without interrupting the network service.

This application claims priority to Taiwan Patent Application No. 098124703 filed on Jul. 22, 2009.

### CROSS-REFERENCES TO RELATED APPLICATIONS

Not applicable.

### BACKGROUND OF THE INVENTION

1. Field of the Invention

The present invention provides a mobile node, a take-over point of attachment (PoA) and a handover method thereof for use in a heterogeneous wireless network system. In particular, the present invention provides a mobile node, a take-over point of attachment (PoA) and a handover method thereof that will not cause an interruption to the network service during the handover.

2. Descriptions of the Related Art

With the rapid development of the Internet, the accessing method of networks has evolved from wired networks to wireless networks, for example, those conforming to Wi-Fi specifications specified in IEEE 802.11 and WiMAX (Worldwide Interoperability for Microwave Access) specifications propelled corporately by key communication equipment manufacturers. With the wireless networks, people may take a mobile node with them to access network services provided by the wireless networks.

Generally, wireless networks of different specifications may form a heterogeneous wireless network system, in which a mobile node may hand over among the different wireless networks to maintain a certain level of communication quality. When the mobile node moves away from a service area of a current wireless network, the mobile node must search another wireless network for continued use of the network service, which is the so-called “handover”. In other words, a mobile node may travel across service areas of wireless networks of different accessing technology when it is moving.

Specifically, the heterogeneous wireless network system comprises a gateway for handover management. If, at the outset, the mobile node is positioned in a service area of a Bluetooth wireless network and accesses a network service via a point of attachment (PoA) of the Bluetooth wireless network, it will fail to receive any network service via the PoA of the Bluetooth wireless network when the mobile node moves out of the service area of the Bluetooth wireless network. In this case, the mobile node will proceed with the detection of PoAs of other wireless networks in the vicinity. If the mobile node detects that it is now positioned in a service area of another wireless network (e.g., a Wi-Fi), then it transmits a handover request signal to the gateway so that a series of handover procedures are performed by the gateway in response to the handover request signal to hand over the mobile node from the original Bluetooth wireless network to the PoA of the Wi-Fi wireless network. Finally, the mobile node may continue to receive the network service via the PoA of the Wi-Fi wireless network.

As a result of the conventional technology, the mobile node begins to search for PoAs of other wireless networks only after it has left the service area of the current wireless network, and interruptions to the network services are often caused during the handover, resulting in the degradation of communication quality. Accordingly, it is important for those skilled in the art to prevent the interruption of network services caused during the handover of a mobile node.

### SUMMARY OF THE INVENTION

An objective of the present invention is to provide a mobile node for use in a heterogeneous wireless network system. The heterogeneous wireless network system comprises a gateway, a first wireless network and a second wireless network that is heterogeneous to the first wireless network. The first wireless network comprises a take-over point of attachment (PoA), while the second wireless network comprises an original PoA which exchanges messages with the take-over PoA via the gateway. There is an overlapping service area between the take-over PoA and the original PoA. Currently the mobile node is receiving a network service provided by the gateway via the original PoA.

The mobile node comprises a storage module, a first network interface, a second network interface and a process module. The storage module is configured to store connection information related to the original PoA. The first network interface is compatible with the first wireless network, while the second network interface is compatible with the second wireless network and configured to receive the network service. When determining that the mobile node has entered the overlapping service area, the process module generates a determination result. According to the determination result, the first network interface transmits a link request signal to immediately establish a link of a data link layer with the take-over PoA. The first network interface further transmits the connection information and a first handover request signal to the take-over PoA via the link respectively. Then according to the connection information and the first handover request signal, a handover procedure is performed jointly by the original PoA, the take-over PoA and the gateway so that the gateway may provide the network service via the take-over PoA. The first network interface is further configured to receive the network service in place of the second network interface.

Another objective of the present invention is to provide a take-over point of attachment (PoA) for use in a heterogeneous wireless network system. The heterogeneous wireless network system comprises a mobile node, a gateway, a first wireless network and a second wireless network that is heterogeneous to the first wireless network. The first wireless network comprises the take-over PoA, while the second wireless network comprises an original PoA which exchanges messages with the take-over PoA via the gateway. There is an overlapping service area between the take-over PoA and the original PoA. Currently the mobile node is receiving a network service provided by the gateway via the original PoA. When the mobile node has just entered the overlapping service area, it transmits a link request signal, connection information related to the original PoA and a first handover request signal in sequence.

The take-over PoA comprises a first network interface, a second network interface, a third network interface, a storage module and a process module. The storage module is configured to store handover information related to the take-over PoA. The first network interface is compatible with the first wireless network, and configured to receive the link request signal and establish a link of a data link layer with the mobile node according to the link request signal. The first network interface is further configured to receive the connection information and the first handover request signal in sequence via the link. The second network interface is compatible with the second wireless network, and the third network interface is compatible with a wired network, via which the take-over PoA may be connected to the gateway. The process module is configured to compose the connection information and the handover information according to the first handover request signal to generate composition information. The third network interface is configured to transmit the first handover request signal and the composition information to the gateway so that a handover procedure is performed jointly by the gateway, the second network interface and the original PoA according to the first handover request signal and the composition information. After completion of the handover procedure, the gateway may provide the network service to the mobile node via the first network interface of the take-over PoA.

Yet another objective of the present invention is to provide a handover method for use in a mobile node of a heterogeneous wireless network system. The heterogeneous wireless network system comprises a gateway, a first wireless network and a second wireless network that is heterogeneous to the first wireless network. The first wireless network comprises a take-over point of attachment (PoA), while the second wireless network comprises an original PoA which exchanges messages with the take-over PoA via the gateway. There is an overlapping service area between the take-over PoA and the original PoA. Currently, the mobile node is receiving a network service provided by the gateway via the original PoA. The mobile node comprises a first network interface, a second network interface, a storage module and a process module. Therein, the storage module is configured to store the connection information related to the original PoA.

The handover method comprises the following steps: (a) enabling the process module to determine that the mobile node has already entered the overlapping service area to generate a determination result; (b) enabling the first network interface to, according to the determination result, transmit a link request signal to immediately establish a link of a data link layer with the take-over PoA; and (c) enabling the first network interface to transmit the connection information and the first handover request signal to the take-over PoA respectively via the link. Thereby, according to the connection information and the first handover request signal, a handover procedure is performed jointly by the original PoA, the take-over PoA and the gateway so that the gateway may provide the network service to the mobile node via the take-over PoA.

Yet a further objective of the present invention is to provide a handover method for use in a takeover PoA of a heterogeneous wireless network system. The heterogeneous wireless network system comprises a mobile node, a gateway, a first wireless network and a second wireless network that is heterogeneous to the first wireless network. The first wireless network comprises the take-over PoA, while the second wireless network comprises an original PoA which exchanges messages with the take-over PoA via the gateway. There is an overlapping service area between the take-over PoA and the original PoA. Currently, the mobile node is receiving a network service provided by the gateway via the original PoA and when the mobile node has just entered the overlapping service area, it transmits a link request signal, connection information related to the original PoA and a first handover request signal in sequence. The take-over PoA comprises a first network interface, a second network interface, a third network interface, a storage module and a process module. Herein, the storage module is configured to store handover information related to the take-over PoA.

The handover method comprises the following steps: (a) enabling the first network interface to receive the link request signal; (b) enabling the first network interface to establish a link of a data link layer with the mobile node according to the link request signal and receive the connection information and the first handover request signal in sequence via the link; (c) enabling the process module to compose the connection information and the handover information according to the first handover request signal to generate composition information; and (d) enabling the third network interface to transmit the first handover request signal and the composition information to the gateway. Thereby, a handover procedure is performed jointly by the gateway, the second network interface and the original PoA according to the first handover request signal and the composition information. After completion of the handover procedure, the gateway may provide the network service to the mobile node via the first network interface.

In summary, the mobile node of the present invention may establish a link with the take-over PoA immediately once it enters the overlapping service area, and when the mobile node requests a handover, it may be handed over to the take-over PoA by the gateway according to the handover request without interruption of network services. In addition, after completion of the handover procedure, the take-over PoA may still keep the connection between the original PoA and the mobile node to facilitate the handover of the mobile node back to the original PoA. Thereby, the drawbacks of the prior art in which network services have to be interrupted during the handover of the mobile node is overcome effectively, and a certain level of communication quality during the handover process is guaranteed for the mobile node.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIGS. 1A-1D illustrate schematic views of a heterogeneous wireless network according to the present invention;

FIG. 1E illustrates a schematic view of a mobile node according to the first embodiment of the present invention;

FIG. 1F illustrates a schematic view of a take-over PoA according to the first embodiment of the present invention; and

FIGS. 2A-2C illustrate a flowchart of the second embodiment of the present invention.

### DESCRIPTION OF THE PREFERRED EMBODIMENT

In the following description, the present invention will be explained with reference to embodiments thereof The present invention relates to a mobile node, a take-over point of attachment (PoA) and a handover method thereof for use in a heterogeneous wireless network system. The present invention allows for the completion of a handover procedure without interruption of network services. It should be appreciated that in the following embodiments and the attached drawings, elements not related directly to the present invention are omitted from depictions; and dimensional relationships among individual elements in the attached drawings are illustrated only for ease of understanding, but not to limit the actual scale.

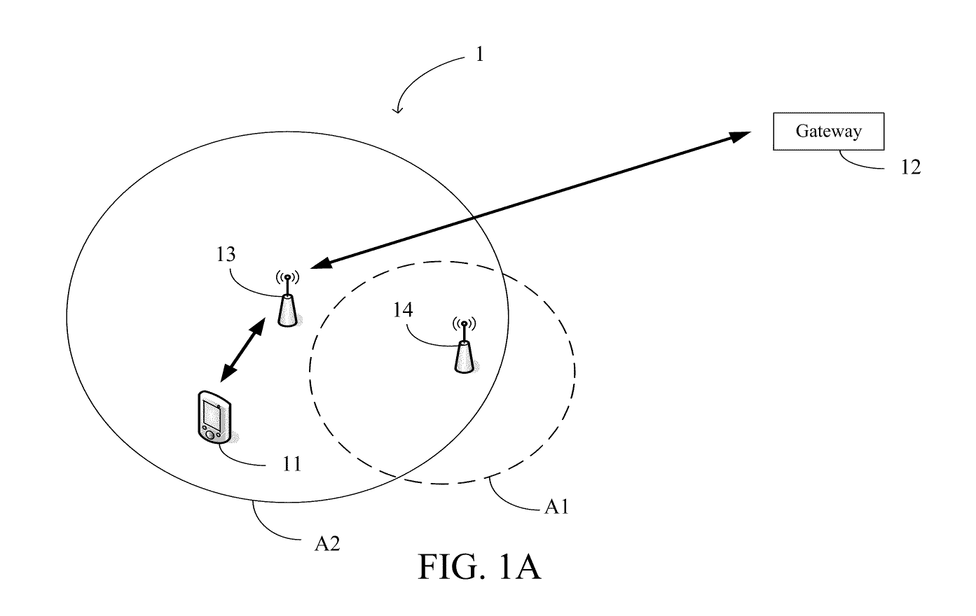

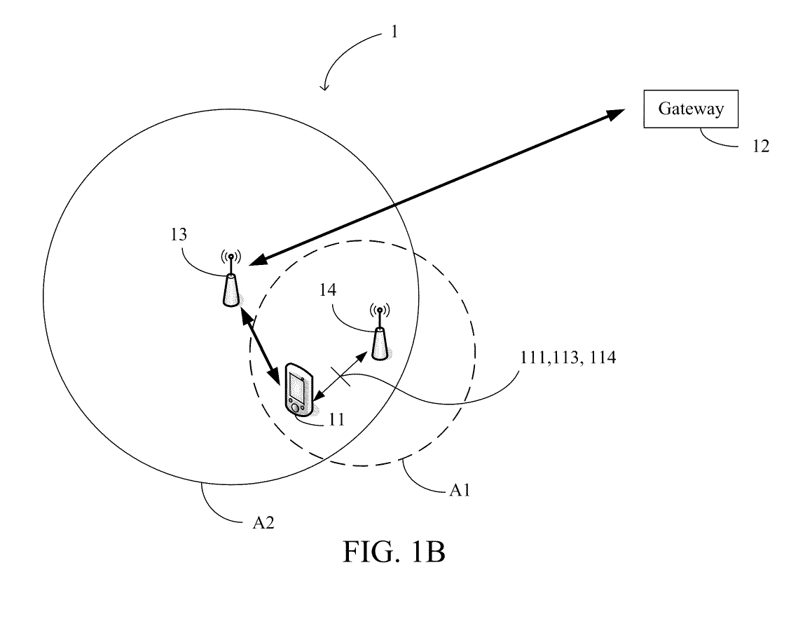

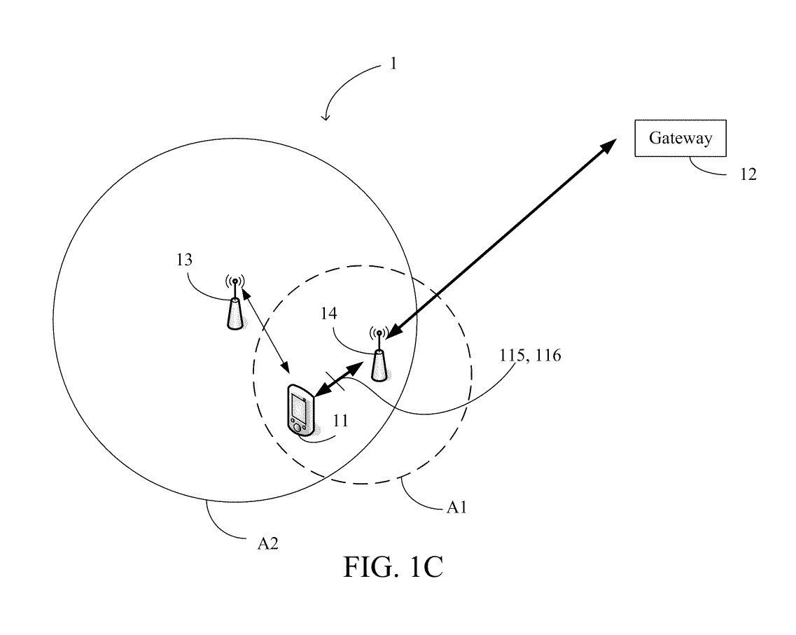

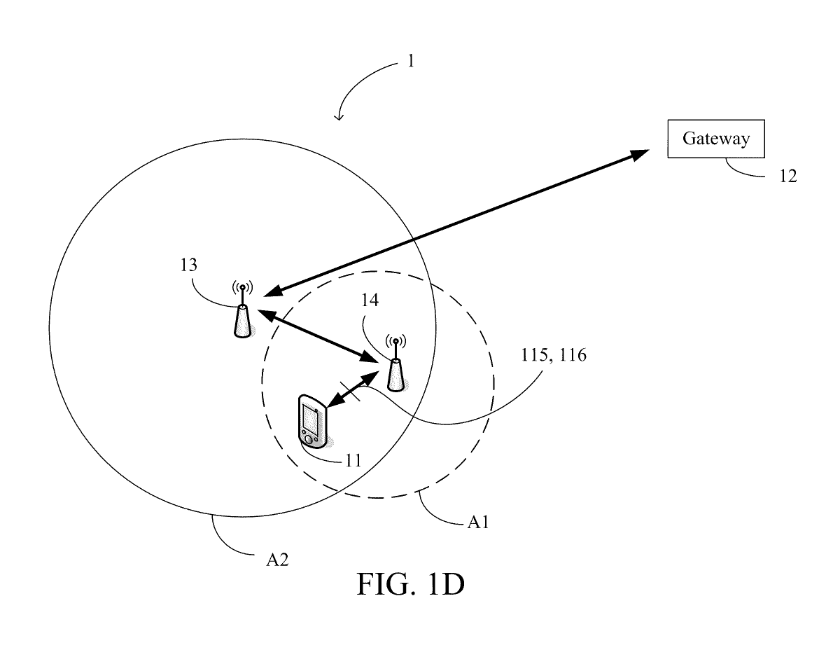

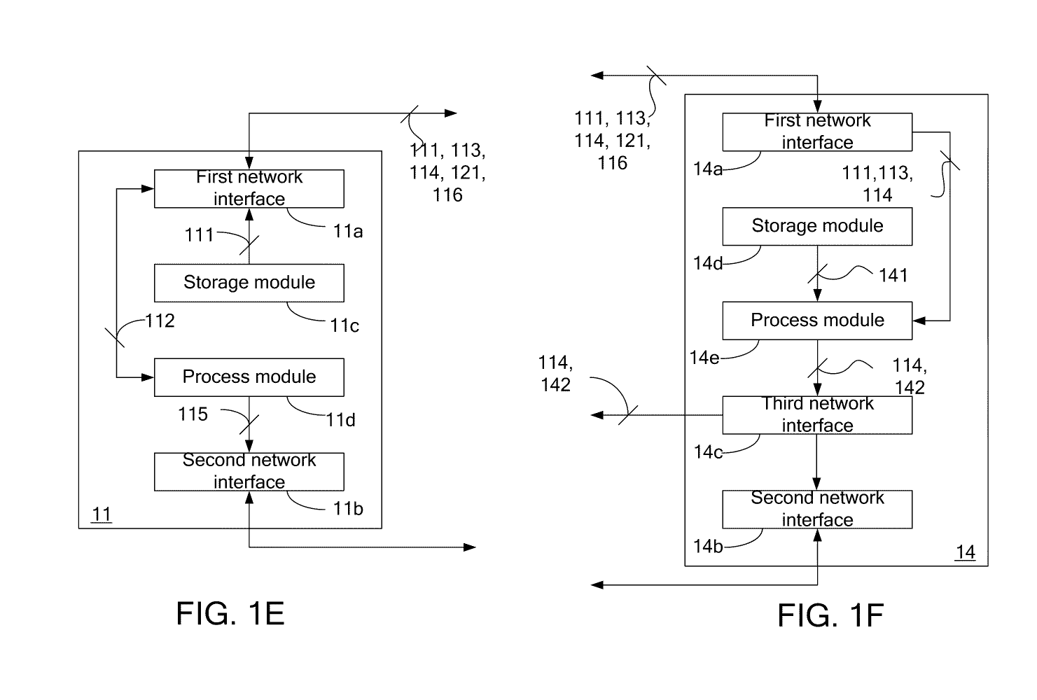

FIGS. 1A-1D illustrate schematic views of a heterogeneous wireless network system 1 according to the present invention. The heterogeneous wireless network system 1 comprises a first wireless network (not shown), a second wireless network (not shown) that is heterogeneous to the first wireless network, a mobile node 11 and a gateway 12. The first wireless network and the second wireless network comprise a take-over PoA 14 and an original PoA 13 respectively. The take-over PoA 14 and the original PoA 13 have a service area A1, A2 respectively. There is an overlapping area (i.e., the region where two circles overlaps with each other in the figure) between the take-over PoA 14 and the original PoA 13 herein. The take-over PoA 14 is connected to the gateway 12 via a wired network to exchange messages with the original PoA 13. In this embodiment, the wired network may be an Ethernet.

In reference to FIG. 1A, the mobile node 11 is originally positioned in the service area A2 of the original PoA 13 so that it currently receives a network service provided by the gateway 12 via the original PoA 13.

Specifically, in reference to FIG. 1E, the mobile node 11 comprises a first network interface 11a, a second network interface 11b, a storage module 11c and a process module 11d. The storage module 11c stores connection information 111 related to the original PoA 13, for example, identification (ID) of the mobile node 11, ID of the original PoA 13 and the modulation mode of the network service received by the mobile node 11. Herein, the first network interface 11a and the second network interface 11b are compatible with the first wireless network and the second wireless network respectively. In other words, the mobile node 11 is currently receiving the network service from the gateway 12 via the second network interface 11b. It should be appreciated that in this embodiment, because the mobile node 11 has the first network interface 11a and the second network interface 11b, the mobile node 11 may receive the network service via either the first wireless network or the second wireless network. In other examples, the mobile node 11 may have multiple network interfaces to receive the network service via more wireless networks of different types.

In reference to FIGS. 1B and 1E, when the mobile node 11 enters the overlapping service area between the first wireless network and the second wireless network, the process module 11d of the mobile node 11 determines that the mobile node 11 has entered the overlapping service area and generates a determination result 112. Then, according to the determination result 112 from the process module 11d, the first network interface 11a transmits a link request signal 113 to immediately establish a link of a data link layer with the take-over PoA 14.

Furthermore, in reference to FIG. 1F, a schematic view of the take-over PoA 14 is illustrated therein. The take-over PoA 14 comprises a first network interface 14a, a second network interface 14b, a third network interface 14c, a storage module 14d and a process module 14e. The storage module 14d is configured to store handover information 141 related to the take-over PoA 14. The first network interface 14a, the second network interface 14b and the third network interface 14c are compatible with the first wireless network, the second wireless network and the aforesaid wired network respectively.

When the mobile node 11 enters the overlapping service area between the first wireless network and the second wireless network as described above, the link request signal 113 from the mobile node 11 is received by the first network interface 14a of the take-over PoA 14. In other words, the first network interface 11a of the mobile node 11 and the first network interface 14a of the take-over PoA 14 exchange control messages with each other according to the link request signal 113 to establish the link of the data link layer. Herein, the control messages are conventional messages necessary for establishing the link of the data link layer and will not be further described again. It should be noted that the mobile node 11 now still receives the network service via the original PoA 13.

After establishment of the link of the data link layer, the mobile node 11 transmits a handover request to the gateway 12 under some conditions, for example, when the quality of the network service accessed via the original PoA 13 is less than the predetermined service quality or when the mobile node 11 has left the service area A2 of the second wireless network.

More specifically, by the link of the data link layer, the mobile node 11 transmits the connection information 111 stored in the storage module 11c and a first handover request signal 114 via the first network interface 11a to the take-over PoA 14. Then, by the link of the data link layer, the first network interface 14a of the take-over PoA 14 receives the connection information 111 and the first handover request signal 114 in sequence from the mobile node 11 and transmits them to the process module 14e. According to the first handover request signal 114, the process module 14e composes the connection information 111 of the mobile node 11 and the handover information 141 of the take-over PoA 14 to generate composition information 142. Subsequently, through the third network interface 14c, the take-over PoA 14 transmits the first handover request signal 114 and the composition information 142 to the gateway 12 via the wired network.

According to the first handover request signal 114 and the composition information 142, a handover procedure is performed jointly by the gateway 12, the second network interface 14b of the take-over PoA 14 and the original PoA 13. Herein, a handover management entity (HOME) of the gateway 12 is responsible for switching the network service originally provided by the original PoA 13 to the take-over PoA 14 and is also responsible for associated conversions, for example, the conversion of the quality of service (QoS), conversion of the data routing, conversion of the packet formats and so on. It should be noted that the handover procedure of this embodiment conforms to the conventional standard handover procedures, which may be readily understood by those skilled in the art and thus will not be further described herein.

After completion of the handover procedure, the gateway 12 transmits a first handover response signal 121 to the first network interface 14a of the take-over PoA 14, and then according to the first handover response signal 121 and the connection information 111 of the mobile node 11, a synchronization procedure is performed jointly by the process module 14e of the take-over PoA 14 and the original PoA 13. In other words, the process module 14e will still keep the connection between the original PoA 13 and the mobile node 11 according to the first handover response signal 121, so the mobile node 11 is still considered to be within the second wireless network from perspective of the original PoA 13. It should be noted that the synchronization procedure between the original PoA 13 and the take-over PoA 14 complies with conventional standard synchronization procedures, which may be readily understood by those skilled in the art and thus will not be further described herein.

Then, the first network interface 14a of the take-over PoA 14 transmits the first handover response signal 121 to the mobile node 11. After the first network interface 11a of the mobile node 11 receives the first handover response signal 121, the process module 11d of the mobile node 11 determines that the handover procedure has been completed and generates a sleep signal 115 according to the first handover response signal 121. Then, according to the sleep signal 115, the second network interface 11b of the mobile node 11 enters a sleep mode. In other words, the network service is provided by the gateway 12 via the take-over PoA 14, and the network service will be received by the first network interface 11a of the mobile node 11 in place of the second network interface 11b, as shown in FIG. 1C. Hence, the second network interface 11b may be powered off temporarily to save power. As shown in FIG. 1D, in other examples, the network service may also be provided by the gateway 12 to the mobile node 11 via the take-over PoA 14 and the original PoA 13, in which case the original PoA 13 must also have a same handover management component as that of the gateway 12 to perform corresponding conversions on the network service received from the take-over PoA 14.

The sleep mode of the second network interface 11b of the mobile node 11 is dynamic. In other words, after completion of the handover procedure, the mobile node 11 will, for some reasons, generate a second handover request signal 116 for handover to the original PoA 13, which is transmitted by the first network interface 11a of the mobile node 11 to the take-over PoA 14. The first network interface 14a of the take-over PoA 14 receives the second handover request signal 116 and further transmits it to the gateway 12. Similarly, a pertinent handover procedure will be performed by the gateway 12 so that the process module 14e of the take-over PoA 14 may restore the connection according to the second handover request signal 116. Once the connection is restored, the gateway 12 may provide the network service to the mobile node 11 via the original PoA 13 again. In other words, the second network interface 11b of the mobile node 11 switches from the sleep mode to the normal mode.

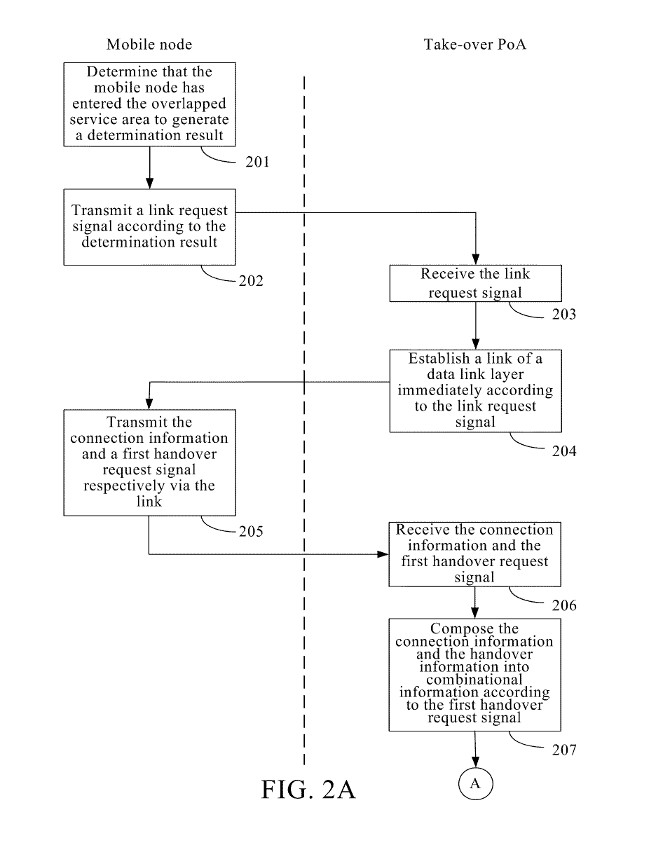

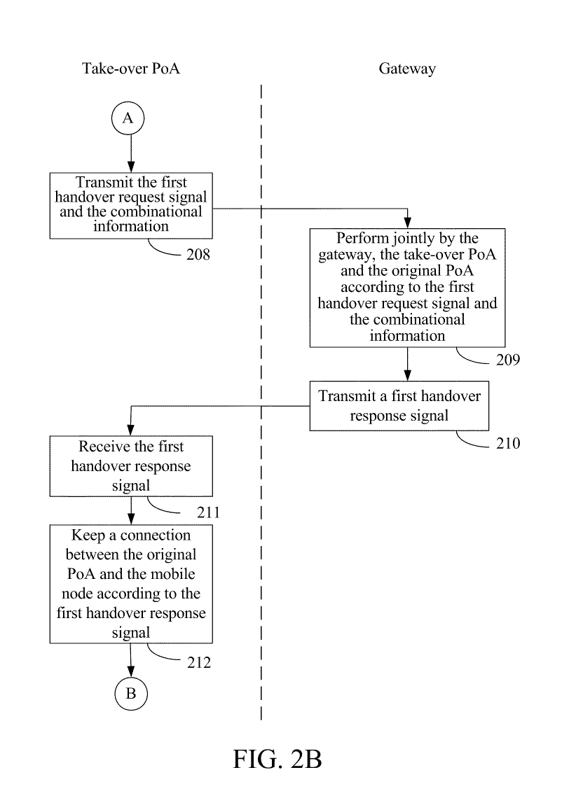

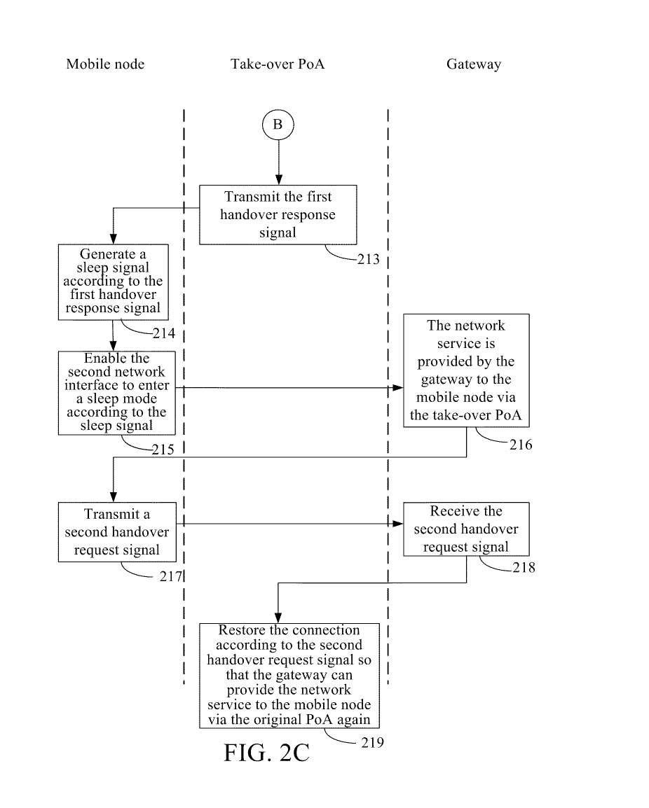

The second embodiment of the present invention is shown in FIGS. 2A-2C, which illustrate the flowcharts of a handover method of a take-over PoA and a mobile mode in a heterogeneous wireless network system. The mobile node and the take-over PoA may be the mobile node 11 and the take-over PoA 14 of the first embodiment. More specifically, the handover method described in the second embodiment may be implemented by a computer program product. When the computer program product is loaded into the mobile node 11 and the take-over PoA 14 by a computer and a plurality of codes included therein are executed, the handover method of the second embodiment may be accomplished. The computer program product may be stored in a computer readable record medium, such as a read only memory (ROM), a flash memory, a floppy disk, a hard disk, a compact disk, a mobile disk, a magnetic tape, a database accessible to networks, or any other storage media with the same function and well known to those skilled in the art.

The heterogeneous wireless network system comprises a gateway, a first wireless network and a second wireless network that is heterogeneous to the first wireless network. The first wireless network comprises the take-over PoA, and the second wireless network comprises an original PoA. The take-over PoA may exchange messages with the original PoA via the gateway, and there is an overlapping service area between the take-over PoA and the original PoA.

The mobile node comprises a first network interface, a second network interface, a storage module and a process module. The first network interface and the second network interface are compatible with the first wireless network and the second wireless network respectively. The storage module of the mobile node is configured to store connection information related to the original PoA.

The take-over PoA comprises a first network interface, a second network interface, a third network interface, a storage module and a process module. The first network interface, the second network interface and the third network interface of the take-over PoA are compatible with the first wireless network, the second wireless network and a wired network respectively. The take-over PoA may be connected to the gateway via the wired network. The storage module of the take-over PoA is configured to store handover information related to the take-over PoA. Currently, the second network interface of the mobile node is receiving a network service provided by the gateway via the take-over PoA.

The handover method of the second embodiment comprises the following steps. In step 201, the process module of the mobile node determines that the mobile node has entered the overlapping service area to generate a determination result. In step 202, according to the determination result of step 201, the first network interface of the mobile node transmits a link request signal to the take-over PoA. The first network interface of the take-over PoA receives the link request signal in step 203, and according to the link request signal, establishes a link of a data link layer with the first network interface of the mobile node immediately in step 204. In step 205, the first network interface of the mobile node transmits the connection information and a first handover request signal to the take-over PoA respectively via the link. Then, in step 206, the first network interface of the take-over PoA receives the connection information and the first handover request signal in sequence.

In step 207, the process module of the take-over PoA composes the connection information and the handover information according to the first handover request signal to generate composition information. In step 208, the third network interface of the take-over PoA transmits the first handover request signal and the composition information to the gateway. In step 209, after the first handover request signal and the composition information are received, a handover procedure is performed jointly by the gateway, the take-over PoA and the original PoA according to the first handover request signal and the composition information. Subsequent to the completion of the handover procedure, the gateway transmits a first handover response signal to the take-over PoA in step 210, while the first network interface of the take-over PoA receives the first handover response signal in step 211. Then, in step 212, the process module of the take-over PoA keeps a connection between the original PoA and the mobile node according to the first handover response signal.

In step 213, the first network interface of the take-over PoA transmits the first handover response signal to the mobile node. In step 214, the first network interface of the mobile node receives the first handover response signal and, according to the first handover response signal, determines that the handover procedure has been completed to generate a sleep signal. In step 215, according to the sleep signal, the second network interface of the mobile node enters a sleep mode. In step 216, the gateway provides the network service to the mobile node via the first network interface of the take-over PoA.

In step 217, the first network interface of the mobile node transmits a second handover request signal to the gateway. Similarly, in step 218, the gateway receives the second handover request signal from the mobile node via the take-over PoA to perform a handover procedure. Finally, in step 219, the process module of the take-over PoA restores the connection according to the second handover request signal so that the gateway may provide the network service to the mobile node via the original PoA again.

In addition to the aforesaid steps, the second embodiment may also execute all the operations and functions of the mobile node and the take-over PoA set forth in the first embodiment. The method in which the second embodiment executes these operations and functions will be readily appreciated by those skilled in the art based on the explanation of the first embodiment, and thus will not be further described herein.

In summary, the mobile node of the present invention may establish a link with the take-over PoA immediately once it enters the overlapping service area, and when the mobile node requests a handover, it may be handed over to the take-over PoA by the gateway according to the handover request without interruption of network services. In addition, after completion of the handover procedure, the take-over PoA may still keep the connection between the original PoA and the mobile node to facilitate the handover of the mobile node back to the original PoA. Thereby, the drawbacks of the prior art in which network services have to be interrupted during the handover of the mobile node is overcome effectively, and a certain level of communication quality during the handover process is guaranteed for the mobile node.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mobile node for use in a heterogeneous wireless network system, the heterogeneous wireless network system comprising a gateway, a first wireless network and a second wireless network heterogeneous to the first wireless network, the first wireless network comprising a take-over point of attachment (PoA), the second wireless network comprising an original PoA, the original PoA exchanging messages with the take-over PoA via the gateway, the original PoA and the take-over PoA having an overlapping service area together, the mobile node being currently receiving a network service provided by the gateway via the original PoA, the mobile node comprising:
a storage module, being configured to store connection information related to the original PoA;
a first network interface, being compatible with the first wireless network;
a second network interface, being compatible with the second wireless network and configured to receive the network service; and
a process module, being configured to determine that the mobile node has entered the overlapping service area to generate a determination result;
wherein the first network interface is configured to, according to the determination result, transmits a link request signal to immediately establish a link of a data link layer with the take-over PoA, and transmit the connection information and a first handover request signal to the take-over PoA respectively via the link, a handover procedure is performed jointly by the take-over PoA, the original PoA and the gateway according to the connection information and the first handover request signal so that the gateway may provide the network service via the take-over PoA to the mobile node, the first network interface is further configured to receive the network service in place of the second network interface.

2. The mobile node as claimed in claim 1, wherein after completion of the handover procedure, the gateway is further configured to transmit a first handover response signal via the take-over PoA, the first network interface is further configured to receive the first handover response signal, the process module is further configured to determine that the handover procedure has been completed according to the first handover response signal to generate a sleep signal, and the second network interface is further configured to enter a sleep mode according to the sleep signal.

3. The mobile node as claimed in claim 2, wherein the take-over PoA may keep a connection between the original PoA and the mobile node according to the first handover response signal, the first network interface is further configured to transmit a second handover request signal to the take-over PoA, and the take-over PoA is configured to restore the connection according to the second handover request signal so that the gateway may provide the network service to the second network interface of the mobile node via the original PoA again.

4. A handover method for use in a mobile node of a heterogeneous wireless network system, the mobile node comprising a first network interface, a second network interface, a storage module and a process module, the heterogeneous wireless network system comprising a gateway, a first wireless network and a second wireless network heterogeneous to the first wireless network, the first wireless network comprising a take-over PoA, the second wireless network comprising an original PoA, the original PoA exchanging messages with the take-over PoA via the gateway, the original PoA and the take-over PoA having an overlapping service area together, the second network interface of the mobile node being currently receiving a network service provided by the gateway via the original PoA, the storage module storing connection information related to the original PoA, the handover method comprising the following steps of:
(a) enabling the process module to determine that the mobile node has entered the overlapping service area to generate a determination result;
(b) enabling the first network interface to, according to the determination result, transmit a link request signal to immediately establish a link of a data link layer with the take-over PoA; and
(c) enabling the first network interface to transmit the connection information and a first handover request signal to the take-over PoA respectively via the link;
wherein according to the connection information and the first handover request signal, a handover procedure is performed jointly by the take-over PoA, the original PoA and the gateway so that the gateway may provide the network service to the mobile node via the take-over PoA.

5. The handover method as claimed in claim 4, wherein after completion of the handover procedure, the gateway is further configured to transmit a first handover response signal via the take-over PoA, and the handover method further comprises the following steps of:
(d) enabling the first network interface to receive the first handover response signal;
(e) enabling the process module to determine that the handover procedure has been completed according to the first handover response signal to generate a sleep signal; and
(f) enabling the second network interface to enter a sleep mode according to the sleep signal.

6. The handover method as claimed in claim 5, wherein the take-over PoA may keep a connection between the original PoA and the mobile node according to the first handover response signal, and the handover method further comprises the following step of:
(g) enabling the first network interface to transmit a second handover request signal to the take-over PoA so that the take-over PoA restores the connection according to the second handover request signal and the gateway may provide the network service to the second network interface of the mobile node via the original PoA again.

7. A take-over PoA for use in a heterogeneous wireless network system, the heterogeneous wireless network system comprising a mobile node, a gateway, a first wireless network and a second wireless network heterogeneous to the first wireless network, the first wireless network comprising the take-over PoA, the second wireless network comprising an original PoA, the take-over PoA being connected to the gateway via a wired network, the original PoA exchanging messages with the take-over PoA via the gateway, the original PoA and the take-over PoA having an overlapping service area together, the mobile node being currently receiving a network service provided by the gateway via the original PoA, the mobile node transmitting a link request signal, connection information related to the original PoA and a first handover request signal in sequence when the mobile node has just entered the overlapping service area, the take-over PoA comprising:
a storage module, being configured to store handover information related to the take-over PoA;
a first network interface, being compatible with the first wireless network, being configured to receive the link request signal and establish a link of a data link layer with the mobile node according to the link request signal, and being further configured to receive the connection information and the first handover request signal in sequence via the link;
a second network interface, being compatible with the second wireless network;
a third network interface, being compatible with a wired network and connected to the gateway via the wired network; and
a process module, being configured to compose the connection information and the handover information according to the first handover request signal to generate composition information;
wherein the third network interface is further configured to transmit the first handover request signal and the composition information to the gateway via the wired network so that a handover procedure is performed jointly by the gateway, the second network interface and the original PoA according to the first handover request signal and the composition information, and the gateway may provide the network service to the mobile node via the first network interface after completion of the handover procedure.

8. The take-over PoA as claimed in claim 7, wherein the gateway is further configured to transmit a first handover response signal after completion of the handover procedure, and the first network interface is configured to receive and transmit the first handover response signal to the mobile node.

9. The take-over PoA as claimed in claim 8, wherein the mobile node transmits a second handover request signal, the process module is further configured to keep a connection between the original PoA and the mobile node according to the first handover response signal, the first network interface is further configured to receive the second handover request signal, and the process module is configured to restore the connection according to the second handover request signal so that the gateway may provide the network service to the mobile node via the original PoA again.

10. A handover method for use in a take-over point of attachment (PoA) of a heterogeneous wireless network system, the heterogeneous wireless network system comprising a mobile node, a gateway, a first wireless network and a second wireless network heterogeneous to the first wireless network, the take-over PoA comprising a first network interface, a second network interface, a third network interface, a storage module and a process module, the first wireless network comprising the take-over PoA, the second wireless network comprising an original PoA, the third network interface being connected to the gateway via a wired network, the storage module being configured to store handover information related to the take-over PoA, the original PoA exchanging messages with the take-over PoA via the gateway, the original PoA and the take-over PoA having an overlapping service area together, the mobile node being currently receiving a network service provided by the gateway via the original PoA, the mobile node transmitting a link request signal, connection information related to the take-over PoA and a first handover request signal in sequence when the mobile node has just entered the overlapping service area, the handover method comprising the following steps of:
(a) enabling the first network interface to receive the link request signal;
(b) enabling the first network interface to establish a link of a data link layer with the mobile node according to the link request signal and to receive the connection information and the first handover request signal in sequence via the link;
(c) enabling the process module to compose the connection information and the handover information according to the first handover request signal to generate composition information; and
(d) enabling the third network interface to transmit the first handover request signal and the composition information to the gateway via the wired network so that a handover procedure is performed jointly by the gateway, the second network interface and the original PoA according to the first handover request signal and the composition information, and the gateway may provide the network service to the mobile node via the take-over PoA after completion of the handover procedure.

11. The handover method as claimed in claim 10, wherein the gateway is further configured to transmit a first handover response signal after completion of the handover procedure, and the handover method further comprises the following step of:
(e) enabling the first network interface to receive the first handover response signal and transmit the first handover response signal to the mobile node.

12. The handover method as claimed in claim 11, wherein the mobile node transmits a second handover request signal, and the handover method further comprises the following steps of:
(f) enabling the process module to keep a connection between the original PoA and the mobile node according to the first handover response signal;
(g) enabling the first network interface to receive the second handover request signal; and
(h) enabling the process module to restore the connection according to the second handover request signal so that the gateway may provide the network service to the mobile node via the original PoA again.
